(19) United States
(12) Patent Application Publication
(10) Pub. No.: US 2023/0291957 A1
(43) Pub. Date: Sep. 14, 2023

(54) DEVICE AND METHOD FOR DISPLAYING VIDEO

(71) Applicant: ARRIS ENTERPRISES LLC, Suwanee, GA (US)

(72) Inventors: Min WEI, Shanghai (CN); Qi WANG, Shanghai (CN); Luyan SUN, Shanghai (CN)

(21) Appl. No.: 18/019,603

(22) PCT Filed: Aug. 9, 2021
(86) PCT No.: PCT/US2021/045138

§ 371 Date: Feb. 3, 2023

(30) Foreign Application Priority Data
Aug. 12, 2020 (CN) 202010806566.9

(51) Int. Cl. H04N 21/43; H04N 21/431; H04N 21/432; H04N 21/433; H04N 21/475

(52) U.S. Cl. CPC H04N 21/43072; H04N 21/4312; H04N 21/4325; H04N 21/4332; H04N 21/4751; H04N 21/4756

(57) ABSTRACT

The present disclosure relates to a device and a method for displaying videos. Specifically, the present disclosure provides an electronic device for displaying videos. The electronic device includes: a processor and a memory. The memory is coupled to the processor and includes an executable instruction stored thereon. When executed by the processor, the executable instruction causes the processor to carry out the following operations: receiving a plurality of videos from one or more user devices and storing the plurality of videos in a queue; determining a weight for each video of the aforementioned plurality of videos in the queue; extracting one or more videos from the queue so that a first number of videos are simultaneously displayed on a display device, wherein the videos in the first number of videos can be selected for full-screen display; for a first video in the first number of videos, determining a full-screen display order and full-screen display time of the first video based on the weight of the first video.

### TECHNICAL FIELD

The present disclosure relates to the field of video display technology, and more specifically, to a device and a method for multi-screen display and full-screen display of videos on a display device.

### BACKGROUND ART

With the development of video display technology, it has been possible to simultaneously display a plurality of videos from one or more user devices on one display device (also referred to as multi-screen display in the present specification). For example, when two user devices are connected to the same wireless access point, their respective video content can be transmitted wirelessly so that two videos are simultaneously displayed on one display device. In a process of multi-screen display, any user device or a third-party device can select a video to zoom in to full-screen display.

### SUMMARY

In some scenes of multi-screen display, the number of videos is large, and each user hopes that the video in his/her own user device can be selected for full-screen display. For example, at a program recording site, the audience cast the videos shot by themselves on the on-site display screen, and they all hope that their own videos can be selected for full-screen display. In this case, it may be impossible to gain a good user experience and feedback simply by determining the full-screen display order of each video according to the transmission order of the videos. In addition, the full-screen display time of each video will also affect the user's viewing experience. Therefore, there is a need for a multi-screen display method that can effectively improve user satisfaction.

According to some aspects of the present disclosure, an electronic device for displaying videos is provided. The electronic device includes a processor and a memory. The memory is coupled to the processor and includes an executable instruction stored thereon. When executed by the processor, the executable instruction causes the processor to carry out the following operations: receiving a plurality of videos from one or more user devices and storing the plurality of videos in a queue (also referred to as “video waiting queue” in the present specification); determining a weight for each video of the plurality of videos in the queue; extracting one or more videos from the queue so that a first number of videos are simultaneously displayed on a display device, wherein a video in the first number of videos can be selected for full-screen display; for a first video in the first number of videos, determining a full-screen display order and full-screen display time of the first video based on the weight of the first video.

In some embodiments, for the aforementioned electronic device, the higher the weight of the first video, the higher the full-screen display order of the first video; and/or the full-screen display time of the first video is positively correlated with the weight of the first video.

In some embodiments, for the aforementioned electronic device, when executed by the processor, the executable instruction further causes the processor to carry out the following operations: selecting a video with the highest weight in the first number of videos from the first number of videos for full-screen display; and after displaying the video in full screen, removing the video or placing the video at the end of the queue, so that other videos in the first number of videos and a video newly extracted from the queue are simultaneously displayed on a display device.

In some embodiments, for the aforementioned electronic device, when executed by the processor, the executable instruction further causes the processor to carry out the following operations: selecting each video in the first number of videos sequentially for full-screen display according to the full-screen display order determined based on the weight; and after displaying the first number of videos in full screen, removing the first number of videos or placing the first number of videos at the end of the queue, so that a first number of videos newly extracted from the queue are simultaneously displayed on a display device.

In some embodiments, for the aforementioned electronic device, the weighting of videos is based on one or more of the following: waiting time of the video in the queue; an activity level of a user device corresponding to the video; a voting status with regard to the video; a top-up status of the user device corresponding to the video; and administrator settings.

In some embodiments, for the aforementioned electronic device, when executed by the processor, the executable instruction further causes the processor to carry out the following operation: regularly updating the weight of each video in the queue.

In some embodiments, for the aforementioned electronic device, the queue follows a First In First Out (FIFO) rule.

In some embodiments, for the aforementioned electronic device, the determination of the first number is based on one or more of the following: display capability of a display device; a total number of videos in the queue; and administrator settings.

According to other aspects of the present disclosure, a method for displaying videos is provided. The method includes: receiving a plurality of videos from one or more user devices and storing the plurality of videos in a queue; determining a weight for each video of the plurality of videos in the queue; extracting one or more videos from the queue so that a first number of videos are simultaneously displayed on a display device, wherein a video in the first number of videos can be selected for full-screen display; for a first video in the first number of videos, determining a full-screen display order and full-screen display time of the first video based on the weight of the first video.

In some embodiments, in the aforementioned method, the higher the weight of the first video, the higher the full-screen display order of the first video; and/or the full-screen display time of the first video is positively correlated with the weight of the first video.

In some embodiments, the aforementioned method further includes: selecting a video with the highest weight in the first number of videos from the first number of videos for full-screen display; and after displaying the video in full screen, removing the video or placing the video at the end of the queue, so that other videos in the first number of videos and a video newly extracted from the queue are simultaneously displayed on a display device.

In some embodiments, the aforementioned method further includes: selecting each video in the first number of videos sequentially for full-screen display according to the full-screen display order determined based on the weight; and after displaying the first number of videos in full screen, removing the first number of videos or placing the first number of videos at the end of the queue, so that a first number of videos newly extracted from the queue are simultaneously displayed on a display device.

In some embodiments, in the aforementioned method, the weighting of videos is based on one or more of the following: waiting time of the video in the queue; an activity level of a user device corresponding to the video; a voting status with regard to the video; a top-up status of the user device corresponding to the video; and administrator settings.

In some embodiments, the aforementioned method further includes: regularly updating the weight of each video in the queue.

In some embodiments, in the aforementioned method, the queue follows a First In First Out (FIFO) rule.

In some embodiments, in the aforementioned method, the determination of the first number is based on one or more of the following: display capability of a display device; a total number of videos in the queue; and administrator settings.

According to other aspects of the present disclosure, it is provided a non-transitory computer readable storage medium including an executable instruction stored thereon, wherein the executable instruction, when executed by one or more processors, causes the processor(s) to carry out the method according to the present disclosure.

According to other aspects of the present disclosure, it is provided an apparatus including parts for executing the method according to the present disclosure.

### BRIEF DESCRIPTION OF THE ATTACHED DRAWINGS

For a better understanding of the present disclosure and to show how to implement the present disclosure, description will be made with reference to the attached drawings by way of examples, wherein:

FIG. 1 is a schematic diagram showing a scene where a video is displayed according to an embodiment of the present disclosure;

FIG. 2 is a schematic diagram showing an electronic device according to an embodiment of the present disclosure;

FIG. 3 is a flow chart showing a method for displaying videos according to an embodiment of the present disclosure;

FIG. 4 is a schematic diagram of displaying videos according to a first example of the present disclosure;

FIG. 5 is a schematic diagram of displaying videos according to a second example of the present disclosure.

It should be noted that throughout the drawings, similar reference numerals and signs refer to corresponding parts. In addition, multiple instances of the same part are designated by a common prefix separated from the instance number by a dash.

### SPECIFIC EMBODIMENTS

The following detailed description is made with reference to the attached drawings, and the following detailed description is provided to help a comprehensive understanding of various exemplary embodiments of the present disclosure. The following description includes various details to help understanding. However, these details are merely considered as examples, not for limiting the present disclosure. The present disclosure is defined by the appended claims and their equivalents. The words and phrases used in the following description are only used to enable a clear and consistent understanding of the present disclosure. In addition, for clarity and brevity, descriptions of well-known structures, functions, and configurations may be omitted. Those of ordinary skill in the art will recognize that various changes and modifications can be made to the examples described in the present specification without departing from the gist and scope of the present disclosure.

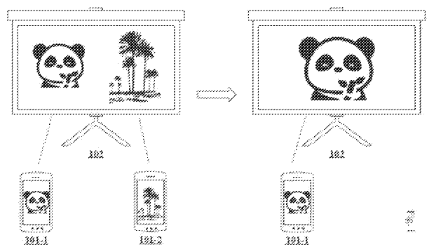

FIG. 1 is a schematic diagram showing a scene where a video is displayed according to an embodiment of the present disclosure. In the scene described in the present disclosure, a plurality of user devices respectively have one or more videos stored locally (for example, videos shot in real time, preliminarily downloaded, or played on a user device through streaming). As an example, FIG. 1 shows two user devices 101-1 and 101-2, wherein the user device 101-1 stores a video relating to an animal, and the user device 101-2 stores a video relating to scenery. The user device 101-1 and 101-2 may respectively transmit the aforementioned two videos to a processing device (not shown), so that the two videos are simultaneously displayed on one display device 102. It should be understood that the processing device may be separated from the display device or integrated with the display device in one device. The screen position and the screen size occupied by the two videos used for multi-screen display on the display device 102 can be specified by the processing device or any user device.

The processing device may select a video from the videos displayed on the multi-screen for full-screen display. As an example, as shown in FIG. 1, the animal-related video corresponding to the user device 101-1 is selected for full-screen display. It should be understood that for simplicity, the present specification describes the video selected by the processing device for full-screen display. In some embodiments, any user device may select a video and interact with the processing device to display the selected video in full screen.

It should be understood that displaying a plurality of videos on the display device 102 requires creating a session for each video, and the session is an http connection via a specific screen sharing protocol. The screen sharing protocol may include but is not limited to Chromecast, Miracast, Airplay, etc.

It should also be understood that the video used for display may be a video from an OTT (over-the-top)/content provider (for example, Tencent Video, iQiyi Video, Youku Video, YouTube, Facebook, Twitter, etc.), or may be a video shot by a user or a video shot and edited via a self-media platform (for example, TikTok, Kuaishou, etc.).

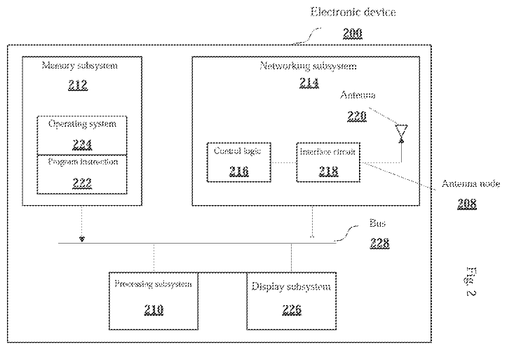

FIG. 2 is a block diagram of an example of an electronic device 200 according to an embodiment of the present disclosure. The electronic device 200 may be used to implement each embodiment of the method according to the present disclosure described in the present specification. The electronic device 200 may include a processing subsystem 210, a memory subsystem 212, and a networking subsystem 214. The processing subsystem 210 includes one or more devices configured to execute a computing operation. For example, the processing subsystem 210 may include one or more microprocessors, ASICs, microcontrollers, programmable logic devices, graphic processing units (GPU), and/or one or more digital signal processors (DSP).

The memory subsystem 212 includes one or more devices for storing data and/or instructions used for the processing subsystem 210 and the networking subsystem 214. For example, the memory subsystem 212 may include a dynamic random access memory (DRAM), a static random access memory (SRAM), and/or other types of memory (sometimes collectively or individually referred to as “computer-readable storage medium”). In some embodiments, the instructions used in the memory subsystem 212 of the processing subsystem 210 include: one or more program modules or instruction sets (for example, a program instruction 222 or an operating system 224), which can be executed by the processing subsystem 210. It should be noted that one or more computer programs may constitute a computer program mechanism. In addition, an instruction in the various modules of the memory subsystem 212 may be implemented by the following: high-level programming language, object-oriented programming language, and/or assembly or machine language. Moreover, the programming language may be compiled or interpreted, for example, configurable or configured (used interchangeably in this discussion), to be executed by the processing subsystem 210.

In addition, the memory subsystem 212 may include mechanism for controlling access to memory. In some embodiments, the memory subsystem 212 includes a memory hierarchy, and the memory hierarchy includes one or more caches coupled to the memory in the electronic device 200. In some of these embodiments, one or more of the caches are located in the processing subsystem 210. In the process of displaying videos, it is usually necessary to reserve a certain storage space (i.e., buffer) for buffering input or output data.

In some embodiments, the memory subsystem 212 is coupled to one or more high-capacity mass storage devices (not shown). For example, the memory subsystem 212 may be coupled to a magnetic or optical driver, a solid state driver, or another type of mass storage device. In these embodiments, the electronic device 200 may use the memory subsystem 212 as a fast-access storage of frequently used data, whereas the mass storage device is used for storing infrequently used data.

The networking subsystem 214 includes one or more devices configured to be coupled to a wired and/or wireless network and communicate over the wired and/or wireless network (i.e., to perform network operations), including: control logic 216, an interface circuit 218, and one or more antennas 220 (or antenna elements). (Although FIG. 2 includes one or more antennas 220, in some embodiments, the electronic device 200 includes one or more nodes, such as node 208, for example, solder pads, that can be coupled to the one or more antennas 220. Therefore, the electronic device 200 may include or not include one or more antennas 220.) For example, the networking subsystem 214 may include a Bluetooth networking system, a cellular networking system (for example, 3G/4G/5G networks, such as UMTS and LTE), a USB networking system, a networking system based on standards described in IEEE 802.11 (for example, Wi-Fi networking system), Ethernet networking system, and/or another networking system.

In the electronic device 200, a bus 228 is used to couple the processing subsystem 210, the memory subsystem 212, and the networking subsystem 214 together. The bus 228 may include electrical, optical, and/or electro-optical connections through which a subsystem may be used to communicate commands, data, etc. Although only one bus 228 is shown for clarity, different embodiments may include different numbers or configurations of electrical, optical, and/or electro-optical connections in the subsystems.

In some embodiments, the electronic device 200 includes a display subsystem 226 for displaying information on a display, and the display subsystem may include a display driver and a display, such as a liquid crystal display, a projection screen, and a multi-touch screen.

The electronic device 200 may be (or may be included in) any electronic device having at least one network interface. For example, the electronic device 200 may be (or may be included in): a desktop computer, a laptop computer, a sub-notebook/netbook, a server, a computer, a mainframe computer, a cloud-based computer, a tablet computer, a smart phone, a cellular phone, a smart watch, a wearable device, a consumer electronic device, a portable computing device, an access point, a transceiver, a controller, a radio node, a router, a switch, a communication device, an access point, a test device, and/or other electronic devices.

Although specific components are used to describe the electronic device 200, in an alternative embodiment, there may be different components and/or subsystems in the electronic device 200. For example, the electronic device 200 may include one or more additional processing subsystems, memory subsystems, networking subsystems, and/or display subsystems. In addition, one or more of the subsystems may not exist in the electronic device 200. Moreover, in some embodiments, the electronic device 200 may include one or more additional subsystems not shown in FIG. 2. In addition, although separate subsystems are shown in FIG. 2, in some embodiments, some or all of the given subsystems or components may be integrated into one or more of the other subsystems or components in the electronic device 200. For example, in some embodiments, the program instruction 222 is included in the operating system 224, and/or the control logic 216 is included in the interface circuit 218.

Moreover, any combination of analog and/or digital circuits may be used to implement the circuits and components in the electronic device 200, including: bipolar, PMOS and/or NMOS gates or transistors. In addition, the signals in these embodiments may include digital signals with approximate discrete values and/or analog signals with continuous values. In addition, the components and circuits may be single-ended or differential, and power supplies may be unipolar or bipolar.

An integrated circuit (sometimes referred to as a “communication circuit” or “device for communication”) can implement some or all of the functions of the networking subsystem 214. The integrated circuit may include hardware and/or software mechanisms, and is used to transmit wireless signals from the electronic device 200 and receive signals at the electronic device 200 from other electronic devices. In addition to the mechanisms described herein, radio devices are generally known in the art, and thus will not be described in detail. Generally, the networking subsystem 214 and/or the integrated circuit may include any number of radio devices. It should be noted that the radio devices in multiple radio embodiments function in a manner similar to that of the described single radio embodiments.

In some embodiments, the networking subsystem 214 and/or the integrated circuit includes a configuration mechanism (such as one or more hardware and/or software mechanisms) that configures the radio to perform transmission and/or reception on a given communication channel (for example, a given carrier frequency). For example, in some embodiments, the configuration mechanism may be used to switch the radio from monitoring and/or transmitting on a given communication channel to monitoring and/or transmitting on a different communication channel. (It should be noted that “monitoring” as used herein includes receiving signals from other electronic devices and possibly performing one or more processing operations on the received signals.)

Although Wi-Fi and/or Ethernet communication protocols are used in the above discussion as illustrative examples, in other embodiments, various communication protocols may be used, and more generally, communication technologies may be used. Therefore, communication technologies can be used in various network interfaces. In addition, although some operations in the aforementioned embodiments are implemented by hardware or software, in general, the operations in the aforementioned embodiments may be implemented in various configurations and frameworks. Therefore, some or all of the operations in the aforementioned embodiments may be executed by hardware, software, or both. For example, at least some operations in the communication technology can be implemented using the program instruction 222, the operating system 224 (such as a driver for the interface circuit 218), or firmware in the interface circuit 218. Alternatively or in addition, at least some operations in the communication technology may be implemented at physical layer, such as hardware in the interface circuit 218.

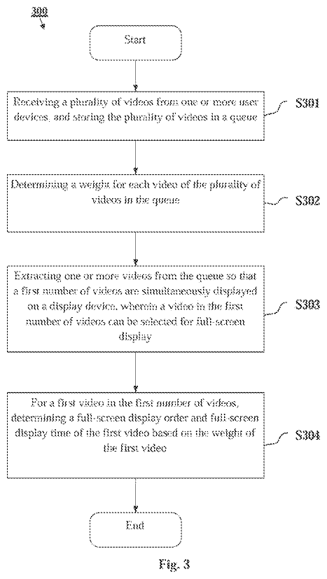

FIG. 3 is a flow chart showing a method 300 for displaying videos according to an embodiment of the present disclosure. As an example, the method may be executed by the processing subsystem 210 in the electronic device 200 shown in FIG. 2. In step S301, a plurality of videos may be received from one or more user devices, and the plurality of videos may be stored in a queue. Then, in step S302, a weight may be determined for each video of the aforementioned plurality of videos in the queue. In step S303, one or more videos may be extracted from the queue, so that a first number of videos are simultaneously displayed on one display device (the display device may be, for example, the display subsystem 226 in the aforementioned electronic device 200), wherein the videos in the first number of videos can be selected for full-screen display. Thereafter, in step S304, for a first video in the first number of videos, the full-screen display order and full-screen display time of the first video may be determined based on the weight of the first video.

According to the example in the present disclosure, when the total number of videos to be displayed is large (that is, the total number of videos is greater than the number of videos in the multi-screen display mode), the videos that have not been displayed may be stored in the queue in the buffer of the memory subsystem 212 (for example, cache) for subsequent display. The queue may follow the First In First Out (FIFO) rule. In other words, the videos can be arranged in the queue according to the order in which the videos are received. According to an embodiment, the number (for example, the aforementioned first number) of videos displayed in the multi-screen display mode is determined based on one or more of the following: display capability of the display device; the total number of videos in the queue; and administrator settings.

According to the method described in the present disclosure, the full-screen display order and full-screen display time of the videos are determined based on the weight. For example, for the first video, the higher the weight of the video, the higher the full-screen display order of the video. Additionally or alternatively, the full-screen display time of the video is positively correlated with the weight of the video (for example, the full-screen display time of the video is equal to the weight of the video multiplied by a predetermined positive coefficient). The criteria for determining the weight will be described in detail below.

According to the present disclosure, the weighting of videos may be based on one or more of the following criteria:
(1) The waiting time of the video in the queue

The weight of the video can be determined based on the waiting time of the video in the queue. As an example, all videos may have the same basic weight. For videos with a long waiting time (for example, the waiting time exceeds a predetermined time threshold), the weight of the video may be appropriately increased (for example, the basic weight is increased by a predetermined value, or is multiplied by a predetermined coefficient greater than 1) so that the video can be preliminarily displayed in full screen and/or displayed in full screen for a longer period of time, thereby improving the satisfaction of the corresponding user.
(2) The activity level of the user device corresponding to the video

The weight of the video may be determined based on computation of the frequency of use and the accumulated operation time of the relevant platform or application of the user device. As an example, for certain program recording or product promotion scenes, if a user often visits a platform or application related to the organizer or manufacturer of the program or product and often performs operations such as hitting “likes,” commenting, or forwarding on the platform or the application, then it indicates that the activity level and loyalty degree of the user to the platform or the application are comparatively high. Accordingly, a relatively high full-screen display order and/or a relatively long full-screen display time may be provided for the video in the user device of the user.
(3) The voting status with regard to the video

Before displaying the videos, a separate vote may be initiated on a specific platform, application, or web site for the videos to be displayed. During voting, all of a video may be shown, or only video clips may be shown. A video with a higher number of votes indicates that the video is more favorable and has higher popularity, and thus can obtain a higher weight. A popular video can be prioritized for full-screen display and/or be allocated a longer full-screen display time. It should be understood that voting can still be carried out during or after the video is displayed in full screen. The voting result may affect the next full-screen display order and/or full-screen display time of the video.

In order to determine which user device the video in the voting system corresponds to, each user device may be assigned a corresponding unique identifier (UID) to identify the user device. As an example, the UID may be bound to the medium access control (MAC) address or other addresses of the user device.
(4) The top-up status of the user device corresponding to the video

The weight of the video may depend on the amount of fees the user pays in the relevant platform or application through the user device, and the criterion is similar to a bidding. As an example, the user can increase the weight by paying more, so as to advance the full-screen display order of the user's video, and can increase the full-screen display time of the video based on the amount of payment.
(5) Administrator settings

The weight of the video may be set by the administrator. The administrator can manually determine the weight of the video based on prior experience and the requirements and/or preferences of the organizer. In addition, the weight of each video may also be automatically computed and determined by training previous data using neural networks and machine learning algorithms.

It should be understood that a comprehensive weight can be determined based on a combination of the aforementioned multiple criteria (for example, each criterion accounts for a certain proportion). It should also be understood that the processing subsystem 210 may determine the weight for each video after the video enters the queue. In addition, the processing subsystem 210 may also periodically update the weight of each video according to the latest data so as to more accurately and more appropriately determine the full-screen display order and the full-screen display time for the video.

As described above, when the total number of videos to be displayed (for example, L videos) is large, except for a plurality of videos (for example, N videos, where N<L, N is also referred to as the first number in the present specification) simultaneously displayed in a multi-screen mode on the display device, other videos may be stored in the video waiting queue for subsequent display. According to the method of the present disclosure, after a certain number of videos (for example, M videos, where M<N) are selected from the N videos for full-screen display, the M videos may be removed or stored at the end of the queue. It should be noted that the number M may be determined by the administrator independently, or may be determined by the administrator after negotiation with one or more users.

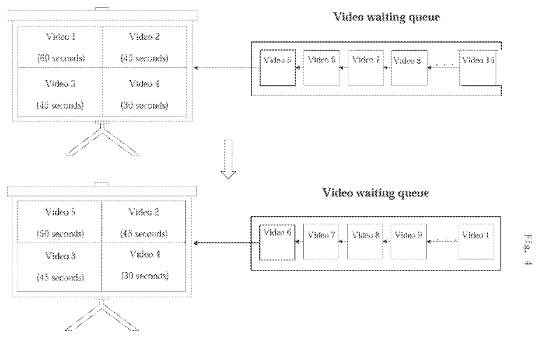

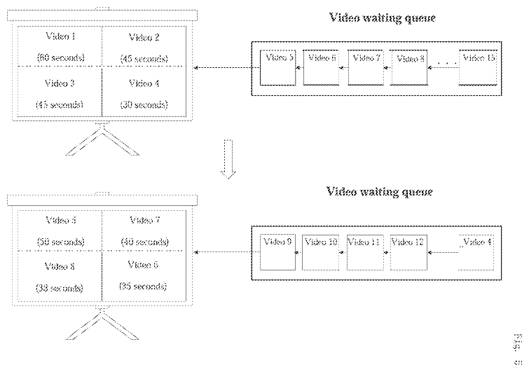

As an example, the user device transmits 15 videos for display in total, that is, L=15. The multi-screen display mode of the display device allows four videos to be displayed at the same time, that is, N=4. FIG. 4 and FIG. 5 are respectively schematic diagrams of displaying videos according to a first example and a second example of the present disclosure with the aforementioned configuration. Specifically, in the first example shown in FIG. 4, M=1 is selected, and in the second example shown in FIG. 5, M=4 is selected.

According to the first example of the present disclosure, as shown in FIG. 4, four videos are displayed in the multi-screen display mode, and a video with the highest weight is selected from the four videos for full-screen display. Specifically, firstly videos 1 to 4 are extracted from the queue for multi-screen display, where the weight of video 1 is 60, the weight of video 2 is 45, the weight of video 3 is 45, and the weight of video 4 is 30. After the four videos are simultaneously displayed for a certain period of time (for example, 5 to 10 seconds), a video with the highest weight (i.e., video 1) among the four videos may be selected based on the weight of each video for full-screen display, and the full-screen display time is equal to the weight multiplied by a predetermined positive coefficient (for example, when the positive coefficient is 1, the full-screen display time of video 1 is 60 seconds).

After video 1 is displayed in full screen, video 1 may be removed or placed at the end of the video waiting queue (FIG. 4 shows an example of placing video 1 at the end of the video waiting queue) so that other videos (i.e., videos 1 to 3) in the four videos and a video newly extracted from the queue (i.e., video 5) are simultaneously displayed on the display device. The weight (50) of video 5 is still the highest among the four videos currently displayed, and thus after videos 1 to 3 and 5 are simultaneously displayed for a certain period of time (for example, 5 to 10 seconds), video 5 may be selected for full-screen display and the full-screen display time is 50 seconds. By this analogy, if the weight of video 6 is still higher than the weight of videos 1 to 3, then video 6 is selected for full-screen display; otherwise, the video with the highest weight among videos 1 to 3 is selected for full-screen display. It should be noted that when a plurality of videos (for example, video 2 and video 3) have the same weight, a video may be selected for full-screen display according to the order in which these videos are arranged in the queue, or a video may be selected for full-screen display according to other predetermined orders.

Preferably, the first example may be used for video display activities that are more of competitions. Specifically, each time the video with the highest weight is selected for full-screen display, and as a result, for example, the most popular videos can be displayed first, while the less popular videos may need to wait for a longer time to have an opportunity for full-screen display.

Similar to the first example, according to the second example of the present disclosure, as shown in FIG. 5, four videos are displayed in the multi-screen display mode, and each video of the four videos is sequentially selected for full-screen display according to the full-screen display order determined based on the weight. Specifically, firstly videos 1 to 4 are extracted from the queue for multi-screen display, where the weight of video 1 is 60, the weight of video 2 is 45, the weight of video 3 is 45, and the weight of video 4 is 30. After the four videos are simultaneously displayed for a certain period of time (for example, 5 to 10 seconds), each video of the four videos may be sequentially selected for full-screen display according to the full-screen display order determined based on the weight, and the full-screen display time is equal to the corresponding weight multiplied by a predetermined positive coefficient (for example, the positive coefficient is 1). Specifically, video 1, video 2, video 3, and video 4 are sequentially displayed in full screen, and the corresponding full-screen display time is 60 seconds, 45 seconds, 45 seconds, and 30 seconds, respectively. It should be noted that when a plurality of videos (for example, video 2 and video 3) have the same weight, the videos may be displayed in full screen according to the order in which these videos are arranged in the queue, or may be sequentially displayed in full screen according to other predetermined orders. In the gap between displaying four videos in full screen, the four videos may be displayed for a short period of time (for example, 2 to 3 seconds), or may be directly switched to the next video for full-screen display without multi-screen display.

After videos 1 to 4 are displayed in full screen, the four videos may be removed or placed at the end of the video waiting queue (FIG. 5 shows an example of placing videos 1 to 4 at the end of the video waiting queue) so that four videos (i.e., videos 5 to 8) newly extracted from the queue are simultaneously displayed on the display device. The weights of videos 5 to 8 are 50, 35, 40, and 38, respectively. Therefore, video 5, video 7, video 8, and video 6 are sequentially displayed in full screen, and the corresponding full-screen display time is 50 seconds, 40 seconds, 38 seconds, and 35 seconds, respectively. It should be noted that the screen positions of the four videos in the multi-screen display mode can be related to the weight, or can be only related to the order in which the videos are arranged in the queue or the video numbers (FIG. 5 shows an example in which the screen position of the video in the multi-screen display mode is related to the weight of the video).

Preferably, the second example may be used for fair entertaining video display activities. Specifically, each video can get a relatively equal display opportunity, and the video transmitted first can usually be displayed earlier. In addition, the second example can complete full-screen display of all videos in a short period of time, thereby saving time and cost to a certain extent.

It should be understood that since the weight of a video may be updated regularly, the same video may have an updated full-screen display time after the weight is updated. For example, after a user's video is displayed in full screen for the first time, the number of votes increases rapidly and the ranking of votes rises rapidly. Therefore, the video can have a higher priority when it is displayed for the second time. That is, the video can be displayed in full screen with higher priority and can have a longer full-screen display time.

According to the embodiments of the present disclosure, multi-screen display and full-screen display of videos can be supported by using the method and the device provided by the present disclosure. By determining the full-screen display order and the full-screen display time of a video based on the weight of the video, videos can be effectively pushed for display based on specific criteria. In addition, according to the method described in the present disclosure, the displayed videos are more in line with user expectations, and can arouse the enthusiasm of users to participate and increase the fun. Therefore, the user satisfaction and user experience can be greatly improved with less cost.

The present disclosure may be implemented as any combination of devices, systems, integrated circuits, and computer programs on non-transitory computer-readable media. One or more processors may be implemented as an integrated circuit (IC), an application specific integrated circuit (ASIC) or a large-scale integrated circuit (LSI), a system LSI, a super LSI, or an ultra LSI component that performs part or all of the functions described in the present disclosure.

The present disclosure includes the use of software, applications, computer programs or algorithms. Software, applications, computer programs or algorithms may be stored on a non-transitory computer-readable medium to make a computer of one or more processors execute the aforementioned steps and steps described in the attached drawings. For example, one or more memories store software or algorithm with executable instructions, and one or more processors can associate a set of instructions for executing the software or algorithm.

Software and computer programs (may also referred to as programs, software applications, applications, components, or codes) include a machine instruction used for a programmable processor, and may be implemented by high-level procedural language, object-oriented programming language, functional programming language, logic programming language, or assembly language, or machine language. The term “computer-readable medium” refers to any computer program product, apparatus, or device used to provide a machine instruction or data to a programmable data processor, such as a magnetic disk, an optical disk, a solid-state storage device, a memory, and a programmable logic device (PLD), including a computer-readable medium that receives a machine instruction as a computer-readable signal.

For example, the computer-readable medium may include a dynamic random access memory (DRAM), a random access memory (RAM), a read-only memory (ROM), an electrically erasable read-only memory (EEPROM), a compact disk read-only memory (CD-ROM) or other optical disk storage devices, a magnetic disk storage device or other magnetic storage devices, or any other medium that can be used to carry or store a required computer-readable program code in the form of an instruction or a data structure and that can be accessed by a general-purpose or special-purpose computer or a general-purpose or special-purpose processor. As used herein, the magnetic disk or disk includes a compact disk (CD), a laser disk, an optical disk, a digital versatile disk (DVD), a floppy disk, and a Blu-ray disk. A magnetic disk usually copies data magnetically, while a disk uses laser to optically copy data. A combination of the above is also included in the scope of a computer-readable medium.

In one or more embodiments, the use of the words “can,” “may,” “operable as” or “configured to” refers to some devices, logic, hardware, and/or elements that are designed to be capable of being used in a specified manner. The subject matter of the present disclosure is provided as an example of an apparatus, a system, a method, and a program for performing the features described in the present disclosure. However, in addition to the aforementioned features, other features or variations may be expected. It may be expected that any newly emerging technology that may replace any of the aforementioned implemented technology can be used to complete the implementation of the parts and functions of the present disclosure.

In addition, the above description provides examples, and does not limit the scope, applicability, or configuration set forth in the claims. The functions and arrangements of the discussed elements may be changed without departing from the gist and scope of the present disclosure. Various processes or parts may be omitted, substituted, or added in various embodiments as appropriate. For example, features described relating to certain embodiments may be combined in other embodiments.

Similarly, although operations are depicted in a specific order in the attached drawings, this should not be understood as requiring such operations to be performed in the specific order shown or in a sequential order, or requiring performing all illustrated operations to achieve a desired result. In some cases, multi-tasking and parallel processing can be advantageous.

1. An electronic device for displaying videos, including:
a processor, and
a memory which is coupled to the processor and includes an executable instruction stored thereon; when executed by the processor, the executable instruction causes the processor to carry out the following operations:
receiving a plurality of videos from one or more user devices and storing the plurality of videos in a queue;
determining a weight for each video of the plurality of videos in the queue;
extracting one or more videos from the queue so that a first number of videos are simultaneously displayed on a display device, wherein a video in the first number of videos can be selected for full-screen display;
for a first video in the first number of videos, determining a full-screen display order and full-screen display time of the first video based on the weight of the first video.

2. The electronic device according to claim 1, wherein:
the higher the weight of the first video, the higher the full-screen display order of the first video; and/or
the full-screen display time of the first video is positively correlated with the weight of the first video.

3. The electronic device according to claim 1, wherein, when executed by the processor, the executable instruction further causes the processor to carry out the following operations:
selecting a video with the highest weight in the first number of videos from the first number of videos for full-screen display; and
after displaying the video in full screen, removing the video or placing the video at the end of the queue so that other videos in the first number of videos and a video newly extracted from the queue are simultaneously displayed on a display device.

4. The electronic device according to claim 1, wherein, when executed by the processor, the executable instruction further causes the processor to carry out the following operations:
selecting each video in the first number of videos sequentially for full-screen display according to the full-screen display order determined based on the weight; and
after displaying the first number of videos in full screen, removing the first number of videos or placing the first number of videos at the end of the queue so that a first number of videos newly extracted from the queue are simultaneously displayed on a display device.

5. The electronic device according to claim 1, wherein the weighting of videos is based on one or more of the following:
waiting time of the video in the queue;
an activity level of a user device corresponding to the video;
a voting status with regard to the video;
a top-up status of the user device corresponding to the video; and
administrator settings.

6. The electronic device according to claim 5, wherein, when executed by the processor, the executable instruction causes the processor to further carry out the following operation:
regularly updating the weight of each video in the queue.

7. The electronic device according to claim 1, wherein the queue follows a First In First Out (FIFO) rule.

8. The electronic device according to claim 1, wherein the determination of the first number is based on one or more of the following:
display capability of a display device;
a total number of videos in the queue; and
administrator settings.

9. A method for displaying videos, including:
receiving a plurality of videos from one or more user devices and storing the plurality of videos in a queue;
determining a weight for each video of the plurality of videos in the queue;
extracting one or more videos from the queue so that a first number of videos are simultaneously displayed on a display device, wherein a video in the first number of videos can be selected for full-screen display;
for a first video in the first number of videos, determining a full-screen display order and full-screen display time of the first video based on the weight of the first video.

10. The method according to claim 9, wherein:
the higher the weight of the first video, the higher the full-screen display order of the first video; and/or
the full-screen display time of the first video is positively correlated with the weight of the first video.

11. The method according to claim 9, further including:
selecting a video with the highest weight in the first number of videos from the first number of videos for full-screen display; and
after displaying the video in full screen, removing the video or placing the video at the end of the queue so that other videos in the first number of videos and a video newly extracted from the queue are simultaneously displayed on a display device.

12. The method according to claim 9, further including:
selecting each video in the first number of videos sequentially for full-screen display according to the full-screen display order determined based on the weight; and
after displaying the first number of videos in full screen, removing the first number of videos or placing the first number of videos at the end of the queue so that a first number of videos newly extracted from the queue are simultaneously displayed on a display device.

13. The method according to claim 9, wherein the weighting of videos is based on one or more of the following:
waiting time of the video in the queue;
an activity level of a user device corresponding to the video;
a voting status with regard to the video;
a top-up status of the user device corresponding to the video; and
administrator settings.

14. The method according to claim 13, further including:
regularly updating the weight of each video in the queue.

15. The method according to claim 9, wherein the queue follows a First In First Out (FIFO) rule.

16. The method according to claim 9, wherein the determination of the first number is based on one or more of the following:
display capability of a display device;
a total number of videos in the queue; and
administrator settings.

17. A non-transitory computer readable storage medium including an executable instruction stored thereon, wherein the executable instruction, when executed by one or more processors, causes the processor(s) to carry out the method described in claim 9.

18. An apparatus including parts for carrying out the method described in claim 9.
